(19) United States
(12) Patent Application Publication
(10) Pub. No.: US 2024/0176999 A1
(43) Pub. Date: May 30, 2024

(54) AUTOMATIC DATA FABRICATION BY COMBINING GENERATIVE ADVERSARIAL NETWORKS

(71) Applicant: International Business Machines Corporation, Armonk, NY (US)

(72) Inventors: Oleg Blinder, Haifa (IL); Omer Yehuda Boehm, Haifa (IL); LEV Greenberg, Haifa (IL); Michael Vinov, Nofit (IL)

(21) Appl. No.: 17/994,429

(22) Filed: Nov. 28, 2022

(51) Int. Cl. G06N 3/08

(52) U.S. Cl. CPC G06N 3/08

(57) ABSTRACT

A computer-implemented method including: training a first Generative Adversarial Network (GAN) based on original structured data; training a second GAN based on fabricated structured data that adhere to user-defined constraints; combining the first and second GANs into a combined GAN; training the combined GAN; and operating the trained combined GAN to generate new fabricated data that both imitate characteristics of the original structured data, and adhere to the user-defined constraints.

### BACKGROUND

The invention relates to the field of machine learning and artificial intelligence.

Generative Adversarial Networks (GANs) are an approach in machine learning concerned with generative modeling using Artificial Neural Network (ANNs) such as Deep Neural Networks (DNNs) and sometime Convolutional Neural Networks (CNNs).

Generative modeling employs unsupervised learning to discover and learn regularities and patterns in input data, such as image data, textual data, structured (tabular) data, etc. Following such learning and discovery (also called ‘training’), the model (the ‘trained’ GAN) may be used to generate new examples of data that plausibly could have been drawn from the original input data. For example, GANs may be used to generate synthetic but realistic images of human faces by learning the regularities and patterns of many real human face images.

The architecture of a typical GAN is comprised of two sub-models: a ‘generator’ model that generates new examples, and a ‘discriminator’ model aimed at classifying these examples as either legitimate (from the domain of the input data) or fake (synthetically generated). Each of these is typically some form of an ANN. The two sub-models are trained together in a zero-sum, adversarial process, until the discriminator sub-model is fooled to think that a fake example is legitimate (and vice versa) in about 50% of cases; this means that the generator sub-model is successfully generating plausible, realistic examples.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment is directed to a computer program product comprising: training a first Generative Adversarial Network (GAN) based on original structured data; training a second GAN based on fabricated structured data that adhere to user-defined constraints; combining the first and second GANs into a combined GAN; training the combined GAN; and operating the trained combined GAN to generate new fabricated data that: imitate characteristics of the original structured data, and adhere to the user-defined constraints.

Another embodiment is directed to a system comprising: (a) at least one hardware processor; and (b) a non-transitory computer-readable storage medium having program code embodied therewith, the program code executable by said at least one hardware processor to: train a first Generative Adversarial Network (GAN) based on original structured data; train a second GAN based on fabricated structured data that adhere to user-defined constraints; combine the first and second GANs into a combined GAN; train the combined GAN; and operate the trained combined GAN to generate new fabricated data that: imitate characteristics of the original structured data, and adhere to the user-defined constraints.

A further embodiment is directed to a computer program product comprising a non-transitory computer-readable storage medium having program code embodied therewith, the program code executable by at least one hardware processor to: train a first Generative Adversarial Network (GAN) based on original structured data; train a second GAN based on fabricated structured data that adhere to user-defined constraints; combine the first and second GANs into a combined GAN; train the combined GAN; and operate the trained combined GAN to generate new fabricated data that: imitate characteristics of the original structured data, and adhere to the user-defined constraints.

In some embodiments, the combined GAN comprises: a generator; two trained discriminators: a trained discriminator obtained from the first GAN, and a trained discriminator obtained from the second GAN; a duplicator configured to deliver every output of the generator to each of the two trained discriminators; and a logic AND gate having an output which is an AND combination of outputs of the two trained discriminators.

In some embodiments, the generator of the combined GAN is a trained generator of the first GAN.

In some embodiments, the training of the combined GAN comprises: using the generator to generate data examples from random latent vectors; using the duplicator to deliver each of the data examples to the two trained discriminators; using each of the trained discriminators to decide whether each of the data examples is legitimate or fake; using the logic AND gate to output an indication of whether or not there is an agreement between the decisions of the two trained discriminators that the respective data sample is real; providing the indication by the logic AND gate as feedback to the generator; continuing the training of the combined GAN until the data example generated by the generator are plausible.

In some embodiments, in the training of the combined GAN, the two trained discriminators remain static and do not undergo retraining.

In some embodiments, the operating of the combined GAN to generate new fabricated data comprises: operating only the generator of the combined GAN to generate the new fabricated data; wherein the duplicator, the trained discriminators, and the logic AND gate do not participate in the generation of the new fabricated data.

In some embodiments, the characteristics of the original structured data comprise properties, dependencies, and intrinsic constraints; and the first GAN, following its training, is configured to generate legitimate data that imitate the properties, dependencies, and intrinsic constraints of the original structured data.

In some embodiments, the second GAN, following its training, is configured to generate legitimate data that adhere to the user-defined constraints.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of an exemplary computing environment, according to an embodiment.

FIG. 2 is a flowchart of a method for automatically generating fabricated data that plausibly imitate characteristics of certain original structured data, and that also adhere to certain user-defined constraints, according to an embodiment.

FIG. 3A is a flow diagram of a training procedure of a first GAN, according to an embodiment.

FIG. 3B is a flow diagram of a training procedure of a second GAN, according to an embodiment.

FIG. 3C is a flow diagram of a training procedure and a structure of a combined GAN, according to an embodiment.

### DETAILED DESCRIPTION

Disclosed herein is a computer-implemented method, also embodied in a system and a computer program product, for automatically generating fabricated data that plausibly imitate characteristics of certain structured data (referred here, for convenience, as ‘original’ data), and that also adhere to certain user-defined constraints. This may be useful in scenarios where a user desires to fabricate (generate) data that imitates that certain original data (which could be, for example, real data that may be subject to privacy regulation, or data that were fabricated to have certain desired characteristics), but wishes for the generated data to also conform to certain constraints that do not exist in that original data. Accordingly, the disclosed method may allow for efficient data fabrication even if the only original data which is available does not fully address the user's requirements.

The disclosed method achieves the above by way of an advantageous combination of at least two GANs, one trained on the original structured data and the other on fabricated structured data that adhere to the user-defined constraints. The combined GAN may include a generator sub-model (‘generator’ for short) and a discriminator sub-model (‘discriminator’ for short) that in fact includes two discriminators—the trained discriminators of the two GANs. The generator may be one of the following: (a) a blank, newly-instantiated generator (that is not pre-trained), (b) the generator of the first GAN (the one trained on the original structured data), or (c) the generator of the second GAN (the one trained on the fabricated structured data).

The combined GAN may further include: (a) a ‘duplicator’—program code that delivers every output of the generator to each of the two trained discriminators, and (b) a logic AND gate—program code that performs an AND combination of outputs of the two trained discriminators.

The combined GAN may undergo training as follows: The generator may generate data examples from random latent vectors. The duplicator may deliver each of the data examples to the two trained discriminators. The trained discriminators may each decide whether each of the data examples is legitimate or fake. The logic AND gate may output an indication as to whether or not both trained discriminators agree that the respective data example is legitimate (real). The indication by the logic AND gate upon such agreement or lack thereof may be provided as feedback to the generator. This training may continue until the data example generated by the generator are plausible, for example until the AND-combined discriminators are fooled to think that a fake (generated) example is real (and vice versa) in about 50% of cases. Note that in this process only the generator is trained, and the two trained discriminators remain static and do not undergo retraining.

The trained, combined GAN may then be operated, as needed, to generate new fabricated data that both imitate characteristics of the original structured data, and adhere to the user-defined constraints.

While, for reasons of conciseness, this disclosure discusses a combination of two GANs, it is also possible to combine a greater number of GANs, for example one GAN trained on the original structured data and multiple GANs each trained on a different set of fabricated data adhering to a different set of user-defined constraints, respectively. This may be useful, for example, in case the user wishes for the newly-fabricated data to adhere to different constraints exhibited in more than one set of fabricated data. The combined GAN, in such case, will naturally have a number of discriminators corresponding to the number of GANs which are combined.

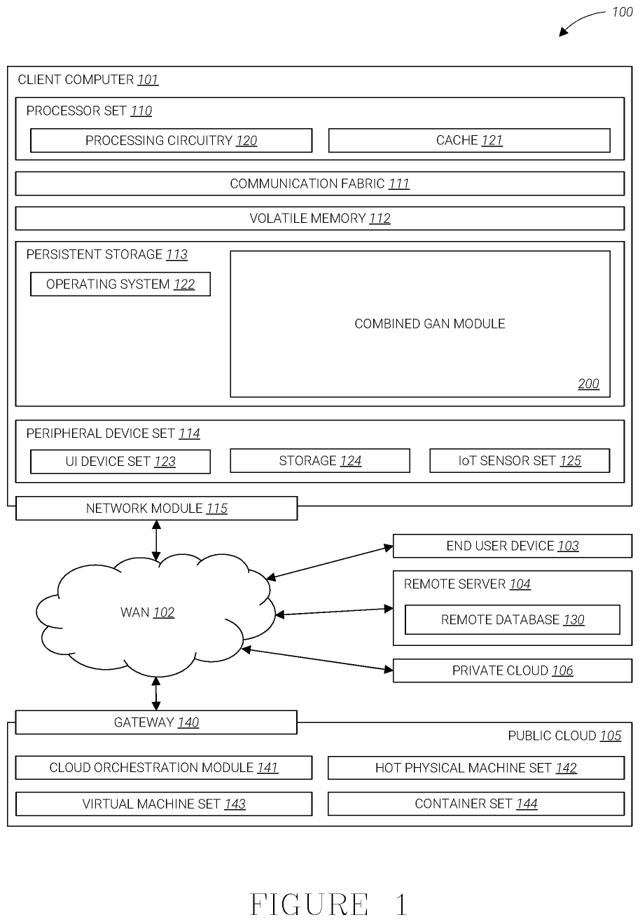

Reference is now made to FIG. 1, which shows a block diagram of an exemplary computing environment 100, containing an example of an environment for the execution of at least some of the computer code involved in performing the inventive methods, such as a combined GAN module 200. In addition to combined GAN module 200, computing environment 100 includes, for example, a computer 101, a wide arca network (WAN) 102, an end user device (EUD) 103, a remote server 104, a public cloud 105, and/or a private cloud 106. In this example, computer 101 includes a processor set 110 (including processing circuitry 120 and a cache 121), a communication fabric 111, a volatile memory 112, a persistent storage 113 (including an operating system 122 and combined GAN module 200, as identified above), a peripheral device set 114 (including a user interface (UI), a device set 123, a storage 124, and an Internet of Things (IOT) sensor set 125), and a network module 115. Remote server 104 includes a remote database 130. Public cloud 105 includes a gateway 140, a cloud orchestration module 141, a host physical machine set 142, a virtual machine set 143, and a container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network and/or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the method(s) specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in combined GAN module 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in combined GAN module 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the Internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as a network interrace controller (NIC), a modem, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through the hardware included in network module 115.

WAN 102 is any wide area network (for example, the Internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

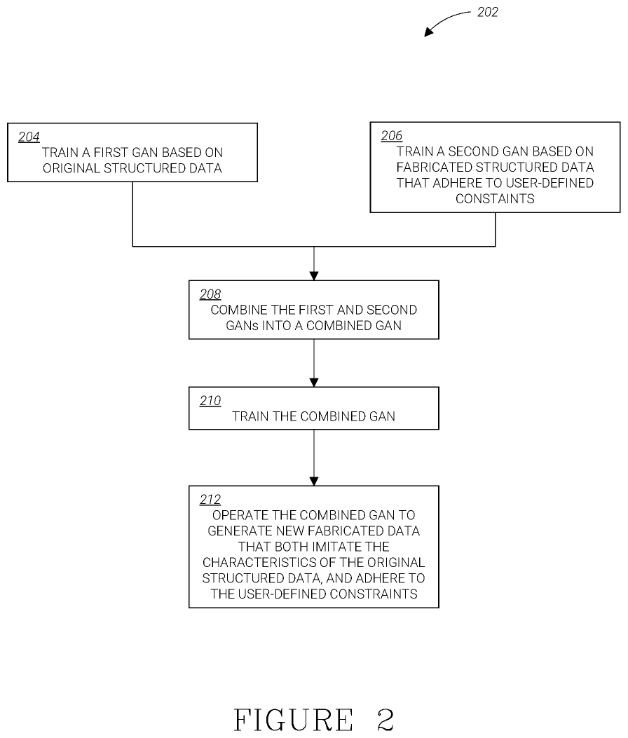

The instructions of combined GAN module 200 are now discussed with reference to the flowchart of FIG. 2, which illustrates a method 202 for automatically generating fabricated data that plausibly imitate characteristics of certain original structured data, and that also adhere to certain user-defined constraints, in accordance with an embodiment.

Steps of method 202 may either be performed in the order they are presented or in a different order (or even in parallel), as briefly mentioned above, as long as the order allows for a necessary input to a certain step to be obtained from an output of an earlier step. In addition, the steps of method 202 are performed automatically (e.g., by computer 101 of FIG. 1, and/or by any other applicable component of computing environment 100), unless specifically stated otherwise.

In a step 204, a first GAN may be trained based on original structured data. The original structured data may include, for instance, real data that has been collected and/or calculated with respect to real entities; for example, data collected from various sensors, medical or financial data as to an individual or a business, and so on and so forth. Alternatively, the original structured data may be data synthetically generated by some data fabrication algorithm such that it exhibits some desired characteristics.

The original data may be ‘structured’ in the sense that it is organized according to certain fields; each record in the data (e.g., a row) may include values for various different fields (e.g., columns). The structure may be represented by a suitable electronic table, database, file, data stream, etc.

The original structured data may have certain characteristics, which may be referred to as properties, dependencies, and/or intrinsic constraints. ‘Properties’ may refer to the type of data in each field, such as whether the value is an integer, a floating-point number, a character string, a Boolean value, etc. ‘Dependencies’ may refer to dependencies between different fields; for example, how values in one field are affected by or derived from values in another field. ‘Intrinsic constraints’ may refer to how the values of a certain field, for all records, are constrained to a certain range, or what their statistical distribution is; for example, values in an ‘Age’ column may be constrained between 0 and 100, or may have a Gaussian distribution having certain mean, standard deviation, and variance.

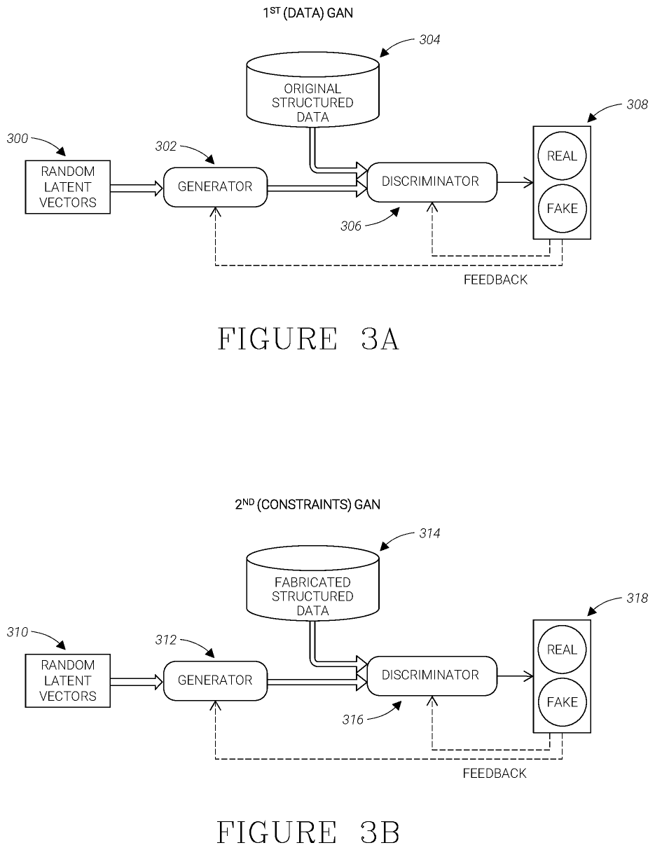

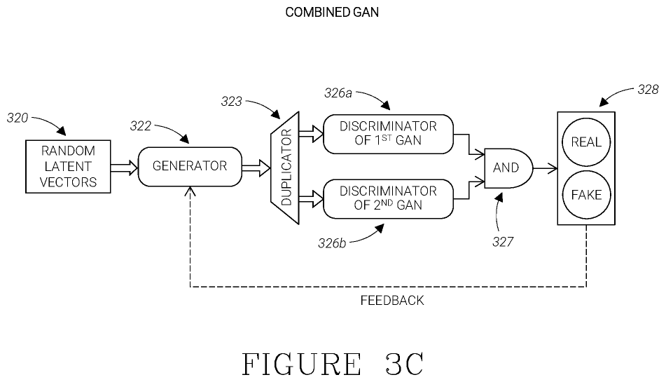

Reference is now made to FIG. 3A, which is a flow diagram of the training of the first GAN, also referred to herein as a “data GAN” as it is associated with original data (the original structured data). The training of the first GAN may be conducted as conventionally known in the art; a generator 302 generates new examples from random latent vectors 300, and a discriminator 306 classifies 308 them as either legitimate (also ‘real’) or fake by comparing them with the original structured data 304; the generator 302 and discriminator 306 are trained together in a zero-sum, adversarial process, until the discriminator 306 is fooled to think that a fake (generated) example is legitimate (and vice versa) in about 50% of cases; this means that the generator 302 is successfully generating plausible examples that realistically appear to be from the domain of the original structured data 304. Accordingly, the trained first GAN may be configured to generate legitimate new data that plausibly imitate the characteristics (e.g., properties, dependencies, and/or intrinsic constraints) of the original structured data 304.

Reference is made back to FIG. 2. In a step 206, a second GAN may be trained, based on fabricated structured data that adhere to user-defined constraints. A user of method 202 may fabricate this structured data either manually or, more commonly, using a data fabrication tool such as the InfoSphere Optim Test Data Fabrication tool by International Business Machines Corporation of Armonk, NY. Such data fabrication tool may be a rule-guided, Constraint Satisfaction Problem (CSP)-driven tool that forms a CSP from rules (constraints) defined by the user, and then solves the CSP to create the fabricated data. The fabricated structured data therefore adhere to these user-defined constraints.

The user-defined constraints may refer to the range, distribution, and/or type of values allowed in each field. For example, an ‘Age’ field may be constrained to the range of 20-30, and/or its values may exhibit a certain distribution. As another example, values in a certain field may be constrained as a function of values in another field; for instance, values in an ‘Education level’ field may be set to increase corresponding to values in an ‘Income’ field. The user may therefore be able to define constraints that are absent from the available original data (based on which the first GAN is trained).

It should be noted that the fabricated structured data does not necessarily include exactly the same fields as the aforementioned original structured data. For example, one or more field names may be overlapping (for example, both sets of data may have an ‘age’ field and an ‘income’ field), while others may be different (for example, the original structured data may have a ‘name’ field while the fabricated structured data may lack such a field). It is also possible that these data do not include any overlapping field names at all.

The fabricated data may be ‘structured’ in the sense that it is organized according to certain fields, as discussed above with respect to the original structured data.

Reference is now made to FIG. 3B, which is a flow diagram of the training of the second GAN, also referred to herein as a “constraints GAN” as it is associated with the fabricated structured data that adheres to user-defined constraints. The training of the second GAN may be conducted as conventionally known in the art; a generator 312 generates new examples from random latent vectors 310, and a discriminator 316 classifies 318 them as either legitimate or fake by comparing them with the fabricated structured data 314; the generator 312 and discriminator 316 are trained together in a zero-sum, adversarial process, until the discriminator is fooled to think that a fake (generated) example is legitimate (and vice versa) in about 50% of cases; this means that the generator 312 is successfully generating plausible examples that realistically appear to be from the domain of the fabricated structured data 314. Accordingly, the trained second GAN may be configured to generate legitimate new data that adhere to the user-defined constraints.

Reference is made back to FIG. 2. In a step 208, the trained first and second GANs may be combined to form a single, combined GAN, that will be ultimately configured to generate new fabricated data that both imitate characteristics of the original structured data, and adhere to the user-defined constraints. In a step 210, the combined GAN may be trained.

Reference is now made to FIG. 3C, which is a flow diagram illustrating the structure of the combined GAN upon training, as well as its manner of training.

A generator 322 of the combined GAN may be one of the following: (a) a blank, newly-instantiated generator, as used in a new, untrained GAN, (b) the trained generator of the first GAN, or (c) the trained generator of the second GAN. In some embodiments it may be advantageous to use the trained generator of the first GAN, as it is has already learned the characteristics of the original structured data, which are typically more complex than characteristics of the fabricated structured data.

A discriminator of the combined GAN may be comprised of: the trained discriminator of the first GAN 326a, the trained discriminator of the second GAN 326b, as well as a ‘duplicator’ 323 and a logic AND gate 327: The duplicator 323 may be program code that is configured to deliver every output of the generator 322 to each of the two trained discriminators 326a-b. The logic AND gate 327, in turn, may be program code (optionally, a trained neural network) that is configured to perform AND combination of the outputs of the two trained discriminators 326a-b, namely, to indicate whether or not they issue agreeing decisions of ‘real’. In other words, the logic AND gate 327 will output ‘real’ only when both trained discriminators 326a-b decide that the output of the generator 322 is ‘real,’ and will output ‘fake’ otherwise (for instance, when one or both trained discriminators 326a-b decide that the output of the generator 322 is ‘fake.’ The following table illustrates the operation of the logic AND gate 327:

TABLE 1
Input and output of the logic AND gate

Input

| Discriminator 1 | Discriminator 2 | Output |
|---|---|---|
| Fake | Fake | Fake |
| Fake | Real | Fake |
| Real | Fake | Fake |
| Real | Real | Real |

The training of the combined GAN may be conducted as conventionally known in the art; the generator 322 generates new examples from random latent vectors 320, and the logic AND gate 327 outputs their classification 328 as either legitimate or fake given the output of the two trained discriminators 326a-b. However, different from conventional GAN training, the two trained discriminators 326a-b may remain static and not undergo retraining; only the generator 322 is trained (or retrained) here, based on feedback from the static discriminators 326a-b, until they are both fooled to think that a fake (generated) example is legitimate (and vice versa) in about 50% of cases; this means that the generator 322 is successfully generating plausible examples that realistically appear to be from an intersection of the domains of the fabricated and original structured data.

Reference is made back to FIG. 2. In a step 212, the trained combined GAN may be operated to generate new fabricated data that both imitate the characteristics of the original structured data, and adhere to the user-defined constraints that were expressed by the fabricated structured data. In practice, only the trained generator 322 (FIG. 3C) of the trained combined GAN is necessary for generating that new fabricated data; the duplicator, the two trained discriminators, and the logic AND gate do not participate in the generation of the new fabricated data.

In conclusion, the advantageous combination of the first and second GANs, with the special manner of training the combined GAN, may allow a user to leverage real, original structured data that do not satisfy the user's desired constraints, and to still be able to fabricate realistic synthetic data that both mimic the real data and satisfy these constraints. The user may then be able to use that synthetic data for purposes such as testing of software programs, training and/or testing of machine learning models, and so on.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In the description and claims, each of the terms “substantially.” “essentially.” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include.” and “have,” as well as forms thereof, are not necessarily limited to members in a list with which the words may be associated.

Where there are inconsistencies between this description and any document incorporated by reference or otherwise relied upon, that the present description shall control.

What is claimed is:

1. A computer-implemented method comprising:
training a first Generative Adversarial Network (GAN) based on original structured data;
training a second GAN based on fabricated structured data that adhere to user-defined constraints;
combining the first and second GANs into a combined GAN;
training the combined GAN; and
operating the trained combined GAN to generate new fabricated data that:
imitate characteristics of the original structured data, and
adhere to the user-defined constraints.

2. The method of claim 1, wherein the combined GAN comprises:
a generator;
two trained discriminators: a trained discriminator obtained from the first GAN, and a trained discriminator obtained from the second GAN;
a duplicator configured to deliver every output of the generator to each of the two trained discriminators; and
a logic AND gate having an output which is an AND combination of outputs of the two trained discriminators.

3. The method of claim 2, wherein the generator is a trained generator of the first GAN.

4. The method of claim 2, wherein the training of the combined GAN comprises:
using the generator to generate data examples from random latent vectors;
using the duplicator to deliver each of the data examples to the two trained discriminators;
using each of the trained discriminators to decide whether each of the data examples is legitimate or fake;
using the logic AND gate to output an indication of whether or not there is an agreement between the decisions of the two trained discriminators that the respective data sample is real;
providing the indication by the logic AND gate as feedback to the generator;
continuing the training of the combined GAN until the data example generated by the generator are plausible.

5. The method of claim 4, wherein:
in the training of the combined GAN, the two trained discriminators remain static and do not undergo retraining.

6. The method of claim 4, wherein the operating of the combined GAN to generate new fabricated data comprises:
operating only the generator of the combined GAN to generate the new fabricated data,
wherein the duplicator, the trained discriminators, and the logic AND gate do not participate in the generation of the new fabricated data.

7. The method of claim 1, wherein:
the characteristics of the original structured data comprise properties, dependencies, and intrinsic constraints; and
the first GAN, following its training, is configured to generate legitimate data that imitate the properties, dependencies, and intrinsic constraints of the original structured data.

8. The method of claim 1, wherein:
the second GAN, following its training, is configured to generate legitimate data that adhere to the user-defined constraints.

9. A system comprising:
(a) at least one hardware processor; and
(b) a non-transitory computer-readable storage medium having program code embodied therewith, the program code executable by said at least one hardware processor to:
train a first Generative Adversarial Network (GAN) based on original structured data,
train a second GAN based on fabricated structured data that adhere to user-defined constraints,
combine the first and second GANs into a combined GAN,
train the combined GAN, and
operate the trained combined GAN to generate new fabricated data that:
imitate characteristics of the original structured data, and
adhere to the user-defined constraints.

10. The system of claim 9, wherein the combined GAN comprises:
a generator;
two trained discriminators: a trained discriminator obtained from the first GAN, and a trained discriminator obtained from the second GAN;
a duplicator configured to deliver every output of the generator to each of the two trained discriminators; and
a logic AND gate having an output which is an AND combination of outputs of the two trained discriminators.

11. The system of claim 10, wherein the generator is a trained generator of the first GAN.

12. The system of claim 10, wherein the training of the combined GAN comprises:
using the generator to generate data examples from random latent vectors;
using the duplicator to deliver each of the data examples to the two trained discriminators;
using each of the trained discriminators to decide whether each of the data examples is legitimate or fake;
using the logic AND gate to output an indication of whether or not there is an agreement between the decisions of the two trained discriminators that the respective data sample is real;
providing the indication by the logic AND gate as feedback to the generator;
continuing the training of the combined GAN until the data example generated by the generator are plausible.

13. The system of claim 12, wherein:
in the training of the combined GAN, the two trained discriminators remain static and do not undergo retraining.

14. The system of claim 12, wherein the operating of the combined GAN to generate new fabricated data comprises:
operating only the generator of the combined GAN to generate the new fabricated data,
wherein the duplicator, the trained discriminators, and the logic AND gate do not participate in the generation of the new fabricated data.

15. The system of claim 9, wherein:
the characteristics of the original structured data comprise properties, dependencies, and intrinsic constraints; and
the first GAN, following its training, is configured to generate legitimate data that imitate the properties, dependencies, and intrinsic constraints of the original structured data.

16. The system of claim 9, wherein:
the second GAN, following its training, is configured to generate legitimate data that adhere to the user-defined constraints.

17. A computer program product comprising a non-transitory computer-readable storage medium having program code embodied therewith, the program code executable by at least one hardware processor to:
train a second GAN based on fabricated structured data that adhere to user-defined constraints;
combine the first and second GANs into a combined GAN;
train the combined GAN; and
operate the trained combined GAN to generate new fabricated data that:
imitate characteristics of the original structured data, and
adhere to the user-defined constraints.

18. The computer program product of claim 17, wherein the combined GAN comprises:
a generator, which is the trained generator of the first GAN;
two trained discriminators: a trained discriminator obtained from the first GAN, and a trained discriminator obtained from the second GAN;
a duplicator configured to deliver every output of the generator to each of the two trained discriminators; and
a logic AND gate having an output which is an AND combination of outputs of the two trained discriminators.

19. The computer program product of claim 18, wherein the training of the combined GAN comprises:
using the generator to generate data examples from random latent vectors;
using the duplicator to deliver each of the data examples to the two trained discriminators;
using each of the trained discriminators to decide whether each of the data examples is legitimate or fake;
using the logic AND gate to output an indication of whether or not there is an agreement between the decisions of the two trained discriminators that the respective data sample is real;
providing the indication by the logic AND gate as feedback to the generator;
continuing the training of the combined GAN until the data example generated by the generator are plausible.

20. The computer program product of claim 19, wherein:
in the training of the combined GAN, the two trained discriminators remain static and do not undergo retraining.
